(19) United States
(12) Patent Application Publication
(10) Pub. No.: US 2005/0278365 A1
(43) Pub. Date: Dec. 15, 2005

(54) Method and software product for storing and retrieving unstructured information

(76) Inventor: Patrick Christian Michael Boucousis, Manly West (AU)

Correspondence Address: David D. Stein;Boyle, Fredrickson, Newholm, Stein & Gratz, S.C., Suite 1030, 250 E. Wisconsin Avenue, Milwaukee, WI, 53202, US

(21) Appl. No.: 11/150,037

(22) Filed: Jun. 9, 2005

(30) Foreign Application Priority Data
Jun. 9, 2004 (AU) 2004903099

(51) Int. Cl. G06F 7/00

(52) U.S. Cl. 707/100

(57) ABSTRACT

A method for operating a computer system to manage unstructured information about objects representing things of interest to an organization. The method involves defining a plurality of two way relationship types between pairs of object types wherein the objects are each instances of the object types. A user of the system is able to define relationships between objects by selecting from a number of relationship types, each of which is compatible with a pairing of object types. The method ensures that each relationship has associated with it a primary end, being a descriptor of the first object type's relationship to the second object type and a secondary end, being a descriptor of the second object type's relationship to the first object type. Preferred embodiments of the method include steps for presenting information about objects and their relationships to other objects including user selected relationship descriptors. Security levels may be associated with objects in order that a user of the system, having a predefined security profile, is restricted to viewing only certain portions of each object's information.

### PRIORITY CLAIM

This application claims priority in Australian Provisional Patent Application No. 2004903099, which was filed Jun. 9, 2004, the full contents and entirety of which is expressly incorporated herein by reference.

### FIELD OF THE INVENTION

The present invention relates to method and system for the management of unstructured information.

### BACKGROUND TO THE INVENTION

Information may be broadly categorized as being either “structured” or “unstructured”. In the context of computer-based information systems, structured information is typically the product of a computer-based process or else it is other information that is easily classified by specific attributes, which are often common across all businesses and industries. Examples include information that has an obvious context such as that concerned with transactions that the organization engages in during the course of business. For the most part this information is “filed” in computer databases by the associated programs as a natural consequence of the processes that created them. A principal characteristic of structured information is that it lends itself to cataloguing and hence storage and convenient retrieval such that members of an organization that are responsible for, or have need of, such information typically know where to store and/or locate it when necessary.

Although most information management systems to date are designed to assist in the storage and retrieval of structured information, it is commonly held that 80 to 90 percent of an organization's tangible information is comprised of unstructured information that is usually not stored in computer systems. Much of this information represents an organization's most valuable knowledge about customers, suppliers, competitors, employees, skills, techniques, products, services and so on

The information may exist on individual PC's where it is not generally accessible by others, in formal hardcopy documents, as informal notes, diary annotations etc. In addition, unstructured information may exist as knowledge in a person's head or as a physical or mental skill possessed by a person. This information is not currently stored in computer systems where it may be more broadly available, or if it is, it is not easily accessed other than in very specific contexts, for a number of reasons including:
I). Conventional current systems employ data structures and associated software programs that are invariably designed with an end use in mind and are not well suited to managing information for which the end use may be ill-defined or not defined at all.
II). Unstructured information is not readily categorized for storage, usually because it is applicable to many subject areas, i.e. it has so many contexts that categorizing to facilitate later retrieval in all possible contexts in which it may be useful, is both difficult and time consuming.
III). People in possession of unstructured information are only able to file it in the contexts that they are personally aware of whilst people that know of other contexts in which it should be filed are unaware of the information to be able to do so.
IV). When looking for information, people do so in the contexts with which they are personally familiar; they look in the places they would expect it to be, which may be different to the places in which other people have elected to store the information.
V). There is a reluctance for people to store their knowledge in centralized storage systems as they may lose control over how it is stored and accessed. A further concern to a person possessing unstructured information is that adding it to a centralized storage system may diminish their personal competitiveness if they are not acknowledged as the source of the information.
VI). Where information is stored centrally, there is a tendency for individuals to also store a personal copy as they have no control over where the central copy will be located, how accessible it will be and for how long it will be retained. This results in duplication and the attendant risk of copies becoming outdated.

The fact that unstructured information is not readily stored and retrieved means that it is not readily accessed by members of the organization that would otherwise benefit from it.

There are presently two main information technology approaches to storing and retrieving unstructured information. The first of these is to structure information by storing it in relational or hierarchical databases. For the most part, these are structured in a way that arranges information for ease of access for a specific purpose, for example particular types of transactions. Information is arranged in tables or files with cross-referencing and indexing facilitating access and enabling records to be related to each other in pre-defined ways. The eventual and intended use of the information is integral to the design of such systems. Individual records are typically identified by keys that software programs use to retrieve or process the records. The keys act as pointers to a record and often cross-references may be provided by having keys point to each other and modern databases and data retrieval programs enable records to be accessed in a number of ways. However, in all cases data is arranged in an explicit structure, which is defined during the design of the database. Two independent records cannot be linked to each other, other than in contexts supported by the database either explicitly or by derivation; certainly they cannot be related in a context unknown to the database. For example Organization A cannot be related to Organization B as a “competitor” unless that relationship exists in the database to be applied. A comment to that effect may be included as text (say) in data fields in the record's of A and B and the records may be retrieved using an appropriate query tool, however that is not the same as their having an explicit Relationship defined within the database. As their record keys are not “pointing” to each other and nor is there any other explicit link a system user's ability to make use of that information is very limited.

If information is to be extracted in ways that were not foreseen when the database was designed, various reporting and/or querying tools may be used to extract it, but the essential limitation of this approach is a dependency on the way information was stored in the first place. Regardless of how user-friendly an information system is there is no easy way for end-users to easily re-arrange underlying data structures to any extent to cater for the entry, storage, relating and retrieval of information that was not catered for when the database was designed. Skilled assistance is needed to create a different data structure and/or to create forms that enable different type of data to be entered. Thus users cannot define information relationships such as relating Assets to organizations as Owners, Financiers, Insurers or People to Organizations as Employees, Benefactors, Shareholders and Organizations to each other as Associates, Competitors and Partners etc unless each of those relationships are defined in the database.

The second approach is to store information as text, e.g. as a document, in a computer system in computer-readable form or as a scanned document where it may be indexed by a program or alternatively it is tagged with keywords by a person. Information that is stored in a physical form i.e. hardcopy, may have information about it entered into a computer system, much like a softcopy document, with instructions to where the physical copy is located. A search engine may then be employed to search for the keywords with which documents were indexed or tagged. Internet-style search engines are a ubiquitous example of this technique, however this method is highly dependent on the structure of the search term that is used and/or the way in which a document has been indexed by a search engine. Further, there is no way for an item of information to be retrieved unless it contains an explicit reference to the search terms a user is likely to use. For example, the description of a welding process to repair a particular metal cannot contain references to every item ever constructed of that material; thus a user who employs a search term such as “repairing holdall buckets” may not find it.

Where information is to be structured, the method is to add context to information as and while it is stored. The context relates to the possible uses of the information either by associating categories with it or by associating it with a particular computer record or records. The method used is to enter data into forms, where data-entry fields give it specific meaning or context, for example where fields in the form ensure data is saved in specific and corresponding columns in data storage tables when the form is saved. This approach is essential to the effective operation of transaction-based systems, where specificity and accuracy are of course paramount. However it does not reflect the way in which humans intuitively perceive and manage information, particularly when it is unstructured. Instead of adding context to information, humans intuitively do the opposite and add information to context as they more naturally think of information in terms of how it might be applied e.g. the problems it solves, than in terms of what it is, i.e. the information itself. Thus in the example above, a particular user is more likely to file the information on welding techniques with “Holdall Buckets” as that is the context in which he/she relates to that item of information; other users may of course file it in different places that have meaning to them e.g. “vehicle repair”.

Current methods for structuring information rely upon the person storing the information being aware of potential uses for the information, e.g. the problems that the information may help to solve and adding that context to the information itself. The failing of this method is that in most instances it is impossible for a person to know of every circumstance in which an item of information will be valuable or useful, and to whom. The addition of further context relies upon other persons becoming aware of the stored information and adding additional context. As current information management practices are strongly biased towards storing it in as few locations as possible, both to secure it and to prevent duplication of the same information and the risk of inconsistent versions, the chances of people discovering information by chance and adding further context to it is diminished. Thus ease of retrieval of information is dependent on it being initially stored with as many references attached to it as may be known. Even if the user is aware of additional contexts in which an item may be stored i.e. to which it might be relevant, there is often no way to place it there as the appropriate form or data entry field on a form does not exist, and neither by extension is the underlying database in a position to store that information.

Where information is structured, as described previously, it is done so in the context of the processes in which data will be used, for example, organization A's information system may have a file or table in the customer sub-system that contains details of organization B for use in the context of customer-related processes such as invoicing, debtor management and so on. Similarly, if company B is also a supplier it will be entered in A's supplier sub-system for the purposes of purchasing processes and creditor management. The database(s) of A's systems would be structured in such a way that relationships are defined between A and B as a customer and as a supplier. In most systems these would be separate relationships, with the customer system unaware of the existence of B as supplier and vice versa, thus a record about B would occur in both systems with the requirement to duplicate at least some information, with the attendant risk of conflicting information. Alternatively, the database may be structured in such a way that there is a single record for B to which both the customer and supplier systems “point”. In any event, these relationships would be defined at the time the database was designed, which requires specific skills.

This is an example of the same information (details of “B”) being relevant in just two contexts, however if the many other ways in which two organizations may be related are considered, for example, as partners, competitors, re-sellers, subsidiaries, departments, agents and so on, the list is of potential relationships is large. If this is now extended to include all possible contexts in which other “objects” of interest to A may be related to each other, for example, people, products, assets, projects, documents the combinations are virtually unlimited. It will be appreciated that it would be impossible to cater for this variety in any practical way using current methods and even if it were, any single user organization would only have use for those relationship that are relevant to them. Furthermore, existing systems are principally concerned with first and second-party relationships the user organization has i.e. internal to the organization and directly with others, not with third-party relationships between other organizations where the user organization is not a party to the relationship.

The problem is that the majority of relationships between the objects of interest to organizations are not relevant to transaction-oriented processes, and do not need to be defined in the associated systems. Using the previous example, the fact that B is a customer of A is of limited relevance to the transaction processes performed in the Customer system nor is the fact that B is a supplier to A of particular relevance to the Supplier processes. However that information is of relevance to anyone in organization A that is concerned about the extent of its relationship with B. Further, it is of no consequence to either system what relationships B has with organizations C, D or E for example; this information is not required for computer-based processes but by people wishing to gain knowledge of those organizations and their relevance to each other.

As an illustration of the challenges presented by unstructured information consider the following example. Suppose that Mary Smith of organization “ABC Car Sales” learns that John Doe has just joined organization “Orange Cabs” and will be a major influencer in an opportunity that A has to sell vehicles to Orange Cabs. Mary also learns that John Doe used to work for “Allied Transportation” where he influenced a large purchase from “Taylor Vehicle Co”, a competitor to ABC, which caused ABC to lose the sale; information previously unknown to anyone in ABC. This information is likely to be of interest to anyone with an interest in Orange Cabs, Allied Transportation, Taylor Vehicle Co, John Doe and/or the previous (lost sale) and current opportunities and it would be ideal if Mary could make the information available to them. However, it is unlikely she would know who the potentially interested people in ABC are, so she is likely to email just those individuals she knows of, who may in turn forward the information to others. Each recipient must then decide what to do with the information; thus many people become involved in handling the same item of information with the attendant duplication of effort. The ubiquitous “For Your Information” email that is part of almost every worker's life these days is an example of this, however it does nothing with the information per se in terms of permanently locating it where it may be useful.

If instead, Mary was easily able to “place” the information in all of the places where those that needed it would discover it as and when they needed it and at the same time advise those that she knew of that this has happened, she would save much wasted time, plus ensure information was safely stored for retrieval at any time in the future. With present methods there is no convenient way to do this.

It can be seen that a principal requirement for managing unstructured information is to support the natural behaviour of people by enabling it to be stored in a system in any context that appears relevant to the user that has it. Existing methods do not support this behaviour, as when a system is designed to use structured data the structure is pre-defined i.e. prior to the information being obtained. In addition, the structure usually implies that information is related with respect to the operator of the system as a first or second-party; that is, as an employee or as directly related organization such as (say) a supplier or a customer with respect to the system user, unless explicit structures are created that indicate otherwise for specific pre-defined items of information. The limitation of this approach is that it does not enable Objects not directly related to the host to be placed into context with others such that, for example, a customer/supplier relationship between two organizations, neither of which is the host, can be indicated.

It is generally held that the 80 to 90% of an organization's tangible information that is unstructured does not, by definition, occur as a result of an existing computer-based process and that again, by definition, there is currently no convenient or practical way to enter this information into computer systems as either the database structure or associated applications to do not provide for it.

It is an object of the present invention to provide a method and software product that addresses the above described problem and which is a useful alternative to present approaches.

### SUMMARY OF THE INVENTION

According to a first aspect of the present invention there is provided a method of operating a computer system to manage information about a domain of objects representing things of interest to an organization, said objects being instances of object types of the domain, the method including the steps of:
defining relationship types between pairs of object types each definition including;
   information identifying first and second object types,
   a primary end being a descriptor of the first object type's relationship to the second object type,
   a secondary end being a descriptor of the second object type's relationship to the first object type; and
defining relationships between pairs of objects, each relationship being an instance of a user selected relationship type;
   wherein primary and secondary ends are associated with each relationship on the basis of
   user selection of either the primary or the secondary end of the user selected relationship type, and
   retrieval of the other of said ends from the relationship type definition without user input.

In a preferred embodiment the method includes:
presenting object information of a first object; and
presenting either the first end or the second end of a relationship between the first object and a second object depending on user preference.

The step of defining relationship types preferably involves a dedicated relationship type table.

The step of defining relationships may involve a relationship table including a key to the relationship type table and a column storing keys of each object.

In one embodiment the relationship table includes columns for storing first and second descriptor names.

The method may include defining relationship types between pre-defined pairings of object types only.

In a preferred embodiment the step of presenting object information about the first object includes providing a link to view object information about one or more objects to which the first object is related.

Preferably the method includes restricting operation of the link depending on a security profile of the user.

Security levels may be associate with objects in order that only users with certain predefined security profiles are able to access object information of selected objects.

The method may include checking that no two relationship types have the same end names.

The step of defining relationships between pairs of objects preferably includes checking that said relationships and said pairs of objects are compatible.

In one embodiment the method includes controlling user access to portions of the object information and relationship information in respect of an object on the basis of predefined user security profiles.

According to a further aspect of the present invention there is provided a computer system programmed to implement a method according to the aforedescribed method.

According to a further aspect of the invention there is provided a computer software product comprising media bearing instructions for execution by one or more electronic processors, including instructions to execute a method as described above.

Yet another aspect of the present invention provides an article of manufacture comprising a program storage medium readable by a computer to manage information about a domain of objects representing things of interest to an organization, said objects being instances of object types of the domain, the program storage medium including:
instructions to form definitions of relationship types between pairs of object types each definition including;
   information identifying first and second object types,
   a primary end being a descriptor of the first object type's relationship to the second object type,
   a secondary end being a descriptor of the second object type's relationship to the first object type;
instructions to form definitions of relationships between pairs of objects, each relationship being an instance of a user selected relationship type; and
instructions to associate primary and secondary ends with each relationship on the basis of user selection of either the primary or the secondary end of the user selected relationship type and retrieval of the other of said ends from the relationship type definition without user input.

Further preferred features of the present invention will be described in the following detailed description, which will refer to a number of figures as follows.

### BRIEF DESCRIPTION OF THE DRAWINGS

FIG. 1 is a block diagram of a computer loaded with a software product according to an embodiment of the present invention.

FIG. 2 shows examples of database tables for storing particular Object types.

FIG. 3 is a screen view of an Object record in respect of an organization showing identification and relationship data.

FIG. 4 shows examples of database tables used to define which Objects may be related, how they may be related and those that are actually related.

FIG. 5 is a diagram illustrating the Types of Relationship that a Position-type Object may have with other Objects and in turn, those Objects with other Objects.

FIG. 6 shows a summary overview of the various steps in using the invention.

FIG. 7 shows an example of the sequence and forms used to create Relationship Combinations and Relationship Types.

FIG. 8 shows the forms generated and the sequence of steps that enable an operator of the system find an Object in the system.

FIG. 9 shows the forms generated that enable an operator of the system to define how a First and Second are to be related.

FIG. 10 shows the processing steps used in defining how a First and Second Object are to be related.

FIG. 11 shows the steps following those shown in FIG. 9 and shows the forms generated that enable an operator of the system to access a Second Object to add to a Relationship and to store the Relationship.

FIG. 12 shows the steps following those shown in FIG. 10 and shows the processing steps that enable an operator of the system to access a Second Object to add to a Relationship and to store the Relationship.

FIG. 13 shows Sections of a First and Second Object records that illustrate how each Object is related to the other.

FIG. 14 shows and example of a “filter” form that may is used to retrieve records based on user-entered selection criteria.

FIG. 15. Shows a form for creating a Security Profile that governs a user's access to records and functions in the system.

FIG. 16 illustrates the interrelationship of five document type Objects.

FIGS. 17 illustrates a data table layout to store information about how Objects are related.

FIG. 18 illustrates an alternative data table layout to store information about how Objects are related.

### DETAILED DESCRIPTION OF EXEMPLARY EMBODIMENT

Overview

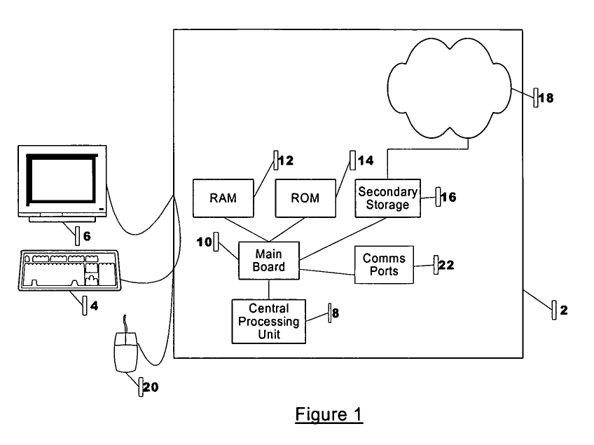

FIG. 1 is a block diagram of a personal computer system upon which a software product according to an embodiment of the present invention may be executed. The system includes a monitor 6, keyboard 4 and mouse 20 all of which are connected to a box 2 containing a main-board 10 that interfaces a central processing unit (CPU) 8 to RAM 12, ROM 14 and a secondary storage device reader 16, and communications ports 22 that enable the computer to be connected to a Network or the Internet. The secondary storage device reader reads instructions from software product 18 being an article of manufacture such as optical or magnetic disks or solid-state memories containing executable instructions. In use CPU 8 operates the computer system according to a method that will be described, by executing instructions borne within software product 18. The end result is that the computer system implements a method that provides an information management system as will be described.

It will be realised that most businesses, except perhaps for home offices and solo practitioner businesses, make use of a network of computers. Accordingly, a preferred embodiment the information management system provided by the present invention comprises a software product that may be accessed on any one of a network of computer workstations. Varying security levels are provided so that access and ability to alter information stored in the information management system is controlled.

Software product 18 includes instructions for creating and managing a Domain of information in which Objects are generated and stored. Objects represent the various things that an organization or organizations responsible for the operation of the Domain are most concerned about e.g. People, Other organizations, Assets, Products, and Services, all being things about which members of an organization typically accumulate knowledge or intelligence. Each type of Object is characterized by identification data that enables each instance of an Object to be uniquely identified, which will be discussed later.

Software product 18 includes instructions that enable a user to relate Objects to other Objects by applying user-defined Relationship Types to them. The software product enforces the definition of two-way relationship where each Object has it's own perspective of the relationship with respect to the other, that is, every relationship is made up of two perspectives, one for each Object, that represent the contexts in which each Object “sees” the other. For example, a Relationship Type may have a first perspective of Supplier to and a second perspective of Customer of, which when applied indicates that if Organization A is a Supplier to Organization B, then by definition, B must be a Customer of A.

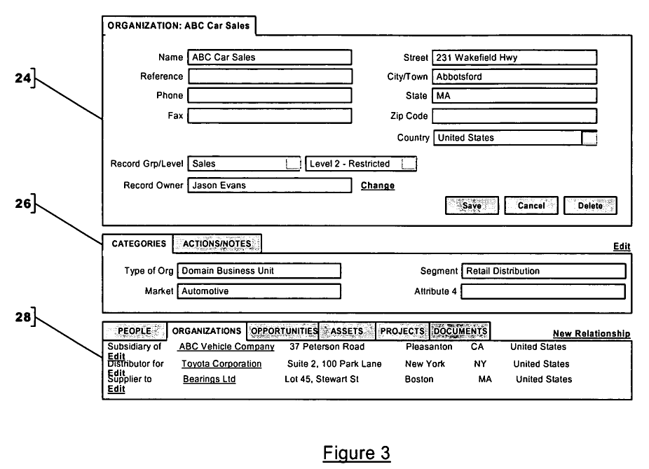

Software product 18 includes instructions for generating a suitable user interface for the entry and editing of object data. For example, FIG. 3 is a view of a form generated on display 6 for a user to view data in respect of an organization-type Object and to relate the Object to other Objects. The form includes a “Header” Section 24 that displays information uniquely identifying the Object and a “Relationship” Section 28, which displays details of all Objects to which the subject Object is related together with Relationship Type for each Relationship.

In addition, Objects may be categorized using generic user-defined “Categories” that have “Attributes” that reflect the attributes objects may have that are of particular interest to the Domain operator; this information is contained in the “Information” section 26 of the record. The actual attributes selected will vary from organization to organization, however the same type of identification data will be used for all organizations.

Software product 18 includes instructions for generating a suitable user interface for the entry of attribute field data. The combination of Objects and their Attributes defines context as a user of the information management system effectively describes Objects in ways that are familiar to them. Similarly the ways in which Objects are related by the application of user-defined Relationship Types places Objects in context with each other in ways that are meaningful to users of the system. Each organization that uses the information management system (Domain operator defines its own Categorization model or lexicon and Relationship Type model that uses terms that are relevant to them; one of the features of the information management system is the framework that enables them to do this.

Defining Relationships between Objects of Interest

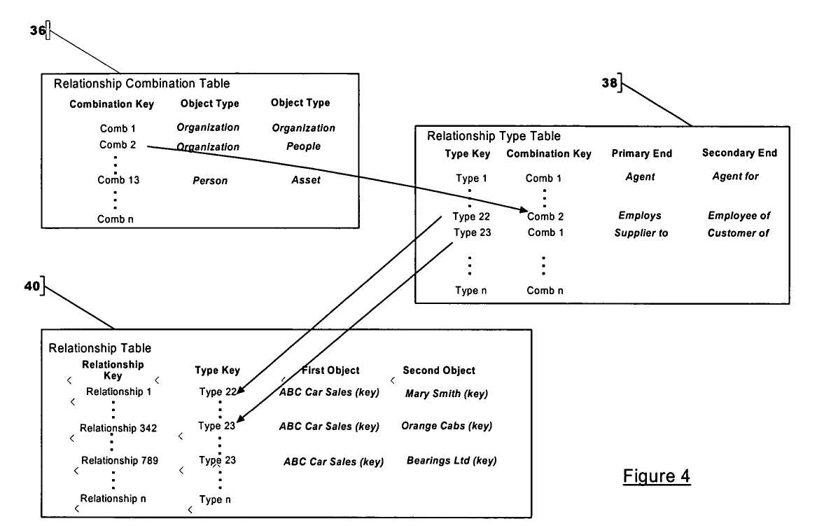

Software product 18 includes instructions for recording combinations of Object type pairs called “Relationship Combinations”. A Relationship Combination is created for each possible pairing of Object types; for example Organizations/Organizations, Organizations/People, People/Assets which are stored in table 36 as shown in FIG. 4. Each Relationship Combination may have one or more user-defined Relationship Types.

A Relationship Type is a single data object that represents a context-sensitive relationship between two Objects of Interest; the context being provided by the Relationship Type having a Primary and Secondary End. Each End is the corollary of the other and represents each Object's perspective of the same Relationship. That is, for a pair of object types related by a Relationship Type, the primary end is a descriptor of the first object type's relationship to the second object type and vice versa. For example, in the case of a customer/supplier relationship, the Primary End may be Supplier to and the Secondary End Customer of. The appropriate End of the Relationship is displayed when an Object is viewed; for example, if the first Object when viewed shows that it is a Supplier to the second Object; the second Object when viewed will show that it is a Customer of the first Object. Details of Relationship Types, including the Primary and Secondary Ends of each are stored in a Relationship Type table such as table 38 of FIG. 4 wherein each row represents a unique occurrence of a Relationship Type Object.

Relationship Types appropriate to their needs are created by operators of the Domain and are then applied as required by users to relate individual occurrences of Objects to other Objects. There is no limit to the number of other Objects an Object may be related to and an Object may be related to the same Object in more than one way.

Relationship Types may be applied to individual pairs of Objects to define a specific type of relationship that applies between them. Since table 38 contains data about a relationship from the perspective of both parties to it, when applying a Relationship to an Object, users need only define one side of a Relationship e.g. the point of view of the Object (First Object) they are currently working with. Software product 18 includes instructions to automatically retrieve the corollary from the Relationship Type Table e.g. where a user defines an organization A as a Head Office of B; A is immediately defined as Branch Office of (if that was how the Primary End and Secondary End fields of the two-way relationship were defined). Each application of a Relationship Type to a pair of Objects is stored in a Relationship Type table depicted as item 40 of FIG. 4. The other Objects to which an Object (First Object) is related may be viewed from the First Object record. In a further embodiment Object records may have a separate Relationship Section, which may be further sub-divided into separate sections by Type of related Object for ease of Navigation as illustrated in From 28 of FIG. 3.

Information sufficient to identify each Related Object (Second Object) is displayed together with the Relationship End representing the First Object's perspective of the Relationship. A user may if desired view the Second Object, for example by means of a hyperlink associated with it, which causes the Second Object record to be displayed provided the user has access permission to the record. When the Relationship Section of the Second Object is viewed, the corollary End to that displayed in the First Object is displayed, together with the First Object's identity. This may also be associated with a hyperlink to enable a user to directly access the First Object record.

All Objects to which an Object is related may be accessed from the Object's record, which enables users to navigate via direct links to related information. As all Relationships are reciprocal, users are able to return to their origin in a single action.

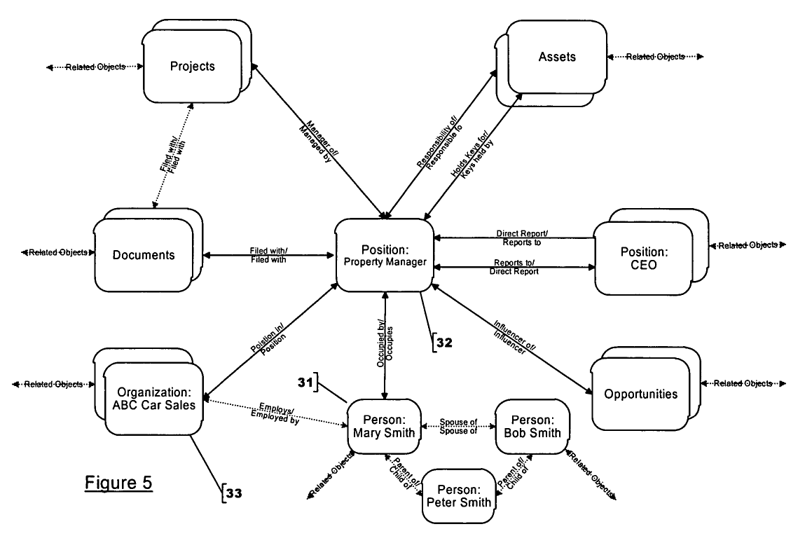

FIG. 5 provides a schematic representation of how Objects may be related by Relationship Type and how they assist users to appreciate the relevance of information. In this case a Job Position 32 of Property Manager is illustrated showing just some of the Relationships that it might have with other Objects, These are by way of example only and there are no limits to the Relationship Types that may be created or that may be applied to a given pair of Objects. It can be seen that when a user views the record for Position 32 they have access to view details of all the other Objects to which the Position is related to and by what Relationship Type. Similarly, when the user views any Second Objects they view details of the corollary Relationship to the First Object as well as relationships that the Second Object has with other Objects. For the purposes of illustration, the diagram shows each Relationship Type as a bidirectional arrow; with each Object's perspective of the relationship i.e. the Primary and Secondary Ends annotated in the form of “First Object/Second Object”. For example, it can be seen that:
Person Mary occupies the Position of Property Manager and the Position Property Manager is occupied by Mary;
Position Property Manager is a Position in ABC Co and ABC Co has a Position Property Manager;
Mary is the Parent of Peter; Peter is the child of Mary It can also be seen that the Second Objects may in turn be related to other Objects by appropriate Relationship Types.

In a further example of how Relationship Types provide specific context, it can be seen in FIG. 5 that Mary 31 is shown to have a professional relationship with organization ABC 33 via a Position 32 in which capacity she is acting on behalf of ABC. She also has separate personal relationships with other Objects, in which case she is acting on her own behalf. Thus there is a clear distinction in context as information may be associated with the Person and/or their Position to clearly indicate whether it relates to the Person acting on behalf of an organization, on behalf of themselves, or both. Where a Person vacates a Position they retain a historical link to the Position and information relating to their acting in the Position stays with the Position. This historical link may also be recorded.

In an example of how Relationship Types may be applied to the situation provided as an example in the “Background to the Invention” contained herein, the invention would enable Mary Smith of organization ABC Car Sales to apply a Relationship Type of Position in to John Doe with respect to Orange Cabs, Previous Occupant of with respect to his former Position at Taylor Vehicle Co, and a Relationship Type of Influencer of with respect to the current Sales Opportunity at Orange Cabs and the earlier lost Opportunity at Allied Transportation. Thus John Doe has been related to the things he influences in that specific context and the information is available in as many “locations” as users are likely to need it. For example, if users now visit the related Objects to discover a) who is influencing the Opportunity at Orange Cabs, or b) who the influencers at Orange Cabs (regardless of Opportunity), or d) who has a Position at Orange, or d) who influenced the loss at Allied Transportation they will see John Doe. This knowledge is now available in the contexts of the related Objects in a), b), c) and d) even though they did not have to be accessed to create it. In addition, Mary only needed to create a single record for each Object; notwithstanding they appear in many different contexts. Each context was provided by means of a Relationship substantially applied by mouse clicks alone.

It can be seen then, that regardless of a user's point of entry to the system in either looking for information or accidentally happening upon it, they will immediately see links to related information, with the Relationship Type denoting it's context and thus relevance to their current needs.

General Usage of Relationship functions

In use, operators of the information management system add new information to Objects as it comes to hand and/or relate, or un-relate, Objects to new or existing Objects as and when the relevance of the information to those Objects becomes apparent. Each user may apply Relationships that are relevant to them, which may be in addition to the Relationships applied by other users; in this way the differing perspectives that individual users may have of the same information is catered for. This operation mimics the manual methods people use to pass information to each other and then file it in locations appropriate to their needs.

Object Categorization

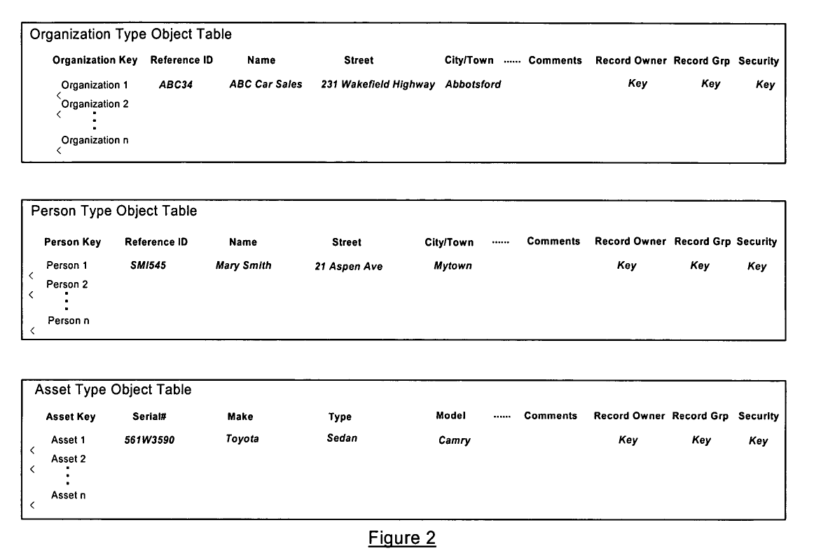

FIG. 2 shows example database tables 3, 5, 7 for storing data defining Organization, Person and Asset type Objects respectively. Each Object type table has a first set of Object type-specific fields for recording information or data that is specific to the particular Object type and which uniquely describes it. The following examples are provided by way of illustration to indicate the type of information that might be used to identify particular Objects.

For an Organization:

Name
Reference ID
Address
   For a Person:
Name
Reference ID
Address
   For an Asset:
Serial Number
Make
Type
Model

In various embodiments of the invention, additional information may be included in Object records according to the data entry fields and associated columns in data storage tables using prior art methods.

Software Product 18 includes instructions that enable users to define their own categorization models for Objects for example:

Person Objects may be categorized according to user-defined Attributes e.g. experience, skills, interests and hobbies.

Organization-type Objects may be categorized according to user-defined Attributes, e.g. purpose, type industry segment, region, role, size and activities.

Position-type Objects are described in terms of user-defined Roles and Attributes that describe what the position does, which are independent of the personal attributes of the Person Object occupying the position. A Person Object may be related to Position Objects as the current or former occupant of any number of positions. A position may also be unoccupied so that it is not related to any person.

Asset-type Objects are products or services that may be owned, sold, bought, used or serviced for example.

Project-type Objects may be any issue or matter that needs managing. A project may have attributes such as objectives, timelines and status.

Sales Opportunities-type objects include details of value, stage of sale and other user-defined criteria.

Document-type Objects are not the stored document per se e.g. a text, image or other documentation type file, but an Object that acts like a virtual container for the document. A Document Object record contains a pointer to the physical location of the document in the database, or some other location, for example a URL in the case of a web-based document. The Document Object behaves in all respects like other Objects in the Domain and may be related to other Objects. The security applied to other Objects also applies to Documents, thus a user's access to a document is governed firstly by their access to the Document Object and then secondly by any security that may have been applied to the document by the software program that it was created with.

A Document Object need not contain a file; it may instead be a reference that contains free-text comments describing the physical location of a hardcopy document external to the system.

Typical Sequence of Use of an Embodiment of the Invention

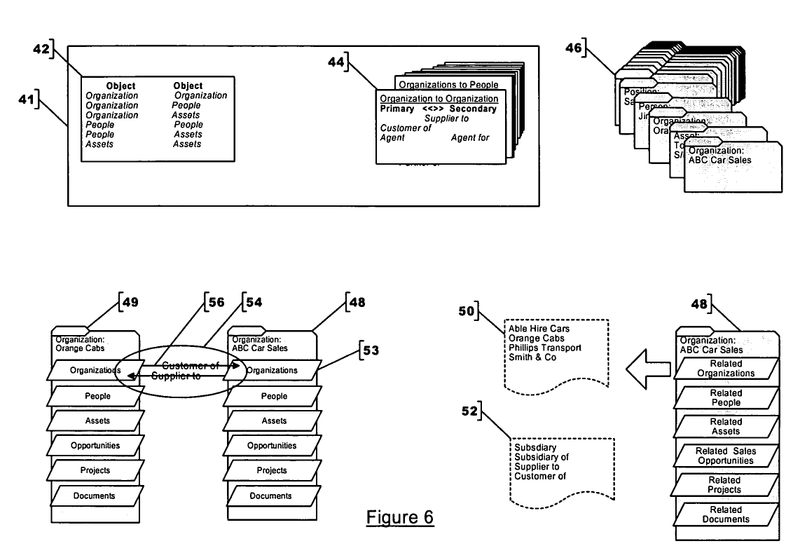

FIG. 6 shows a summary an exemplary method of use of the System by way of an overview, each of the steps of which will be described in detail later.

The method of use is comprised of setup steps 41 where the Domain operator defines Relationship Combinations 42 and Relationship Types 44 for each Combination that are to apply in the Domain as they are relevant to the type of information the Domain operator needs to gather and use in the course of their business. When Relationship Types have been set up, users are able to apply them to individual pairs of Object records 46 to create Relationship records 54 that define the context e.g. “customer—supplier” in which the Objects are related.

To create a Relationship record, the user must visit the First Object record 48, where the user accesses a function to initiate a set of instructions of software product 18 that enables the user to select a Relationship Type from a list 52 that represents the Relationship Ends of Relationship Types that may be applied to the Combination of Object types represented by the First and Second Object. The user then selects a Second Object 49 from a List of Objects 50, whereupon the information system creates a record of the Relationship 54 in the Relationship Table 40 of FIG. 4. The Relationship record stores the First and Second Object keys in the related columns of the Relationship Table, which denote which Object is associated with the Primary End and which Object the Secondary End of the Relationship such that it is correctly oriented with respect to the perspective of each Object 56. The Relationships that an Object has with another are viewable in the Relationship Section of the Object for each related Object Type 53.

An example of the steps involved in the use of a system according to a preferred embodiment of the invention will now be described.

Logging In

A user logs in to a Domain, at which time the server loads into memory the key identifying the user, keys of the Services they have access to and the net effect of their associated Security Profile(s), which are later described. A “cookie” supplied by the server is loaded into the user's Desktop Browser that identifies the user for the logged in session. Alternatively another device may be used to identify the user.

Creating a Relationship Combination

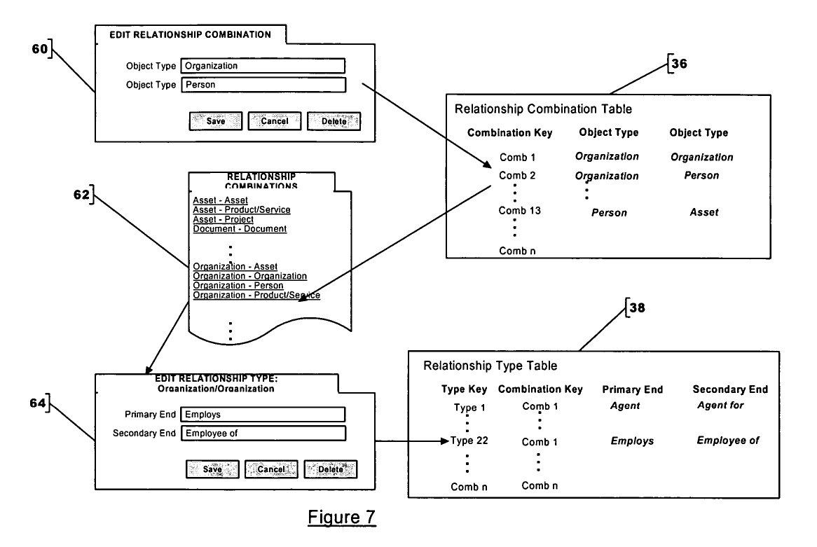

FIG. 7 illustrates a sequence of steps to create a Relationship Combination.

The user executes a procedure to create a Relationship Combination, a security check is performed to ensure the user has access to the related Service

The procedure displays a form such as that illustrated 60, into which the user enters a pair of Object Types; this information is then stored in the Relationship Combination Table 36.

Once Relationship Combinations have been created, users may create one or more Relationship Types for those Combinations as shown in table 62.

In another embodiment, Relationship Combinations may be created by a person skilled in the art by directly accessing the Relationship Combination table and entering the required data. This method is preferred where the Domain operator is not to be given the ability to create new Relationship Combinations beyond those supplied by the supplier of software product 18. This method also simplifies the design of other software applications into which software product 18 has been incorporated as a sub-set of functionality.

Creating a Relationship Type

Items 62, 64 and 38 of FIG. 7 depict a sequence of steps to create a Relationship Type.

The user executes a procedure to create a Relationship Type; a security check is performed to ensure the user has access to the related Service.

In operation, access to the Service would be restricted to ensure that Relationship Types that were created were relevant to the Domain operators needs and to avoid replication of Types. It is not recommended to have Relationship Types with different Primary/Secondary End names that have the same common meaning as other Ends e.g. it would not be advisable to have both Spouse/Spouse and Husband/Wife defined in the same Domain as Relationship Types, as users could then apply either to a given pair of Objects when creating a Relationship, which will lead to confusion.

A procedure displays a list of valid Relationship Combinations 62 from which the user selects the combination for which they wish to create a Relationship Type

A security check is performed to confirm the user has access to the related Service and then a Relationship Type edit form is displayed 64.

The user enters into the “Primary” and “Secondary” End fields of the form the names of the Relationship Ends in a way that connotes the orientation of the Relationship, such that where each Object's perspective of a Relationship is different, the correct perspective is applied to each Object. For example, in the case of an Organization/Person Relationship Type reflecting an employer/employee relationship, an expression such as Employee may be entered as the name of the Primary (Organization's) End and Employee of as the corollary name for the Secondary (Person's) End.

In the preferred embodiment described, the user may easily rectify an error of orientation after the fact. For example if a user has given the wrong names to the Primary and Secondary End such that in the example above, when the Relationship Type is applied to the pair of Objects, the Organization displays as an employee of the Person; the user may edit the Relationship Type record and transpose the Names. As there is only a single occurrence of each Type in the Relationship Type table and as it has a key to which all related records “point”, making the change as described will ensure all Relationship records that are related to that Type will now display with the Relationship Ends correctly orientated when next viewed or used in a process.

In a further embodiment users may specify that Primary and Secondary End names will be unique to a Domain, which provides additional context, as the Types of Object pairs that are the subject of a given Relationship may be inferred from Relationship Type alone.

The record is saved in the Relationship Type Table 38 with a unique key. A Relationship Type should be unique and a duplicate checking process is performed using prior art methods to ensure no two Relationship Types have the same Primary or Secondary End names.

In a preferred embodiment, a further check is performed to ensure that no End name is used more than once in either a Primary or Secondary End.

In operation, Relationship Types may be created by the Domain operator, as and when required.

Creating an Object Record

Software product 18 enables Object records to be created notwithstanding Relationship Types have not been created, however Object types cannot of course be related with user-defined relationships until such time as there are Relationship Types to apply to them.

A user executes a procedure to create a new record or “subject record” of a particular Object type. The procedure may be accessed from the “Accessing an Object” Service that will be described later or from a menu of Services that is provided using prior art methods. The server performs a security check to ensure that the user has access to the Service to be able to create the Object record, for example to create an Organization Object record the user must have the “organizations” Service.

The procedure opens a data entry form such as that illustrated in FIG. 3 related to the Type of Object into which the user enters Object Information identifying the Object in the Header Section 24 and additional Attribute information in the Categories Section 26 if desired.

The user selects a Record Group and Security Level and then saves the record.

The record is stored with a unique key in the relevant Object type Table in the form of those shown in FIG. 2.

Accessing an Object Record

It is a common requirement in using the information system that a user will need to access one or more Object records from a database containing a plurality of records. The following steps describe a set of instructions performed by software 18 that enable users to find the Objects that they wish to work with by using defined search criteria.

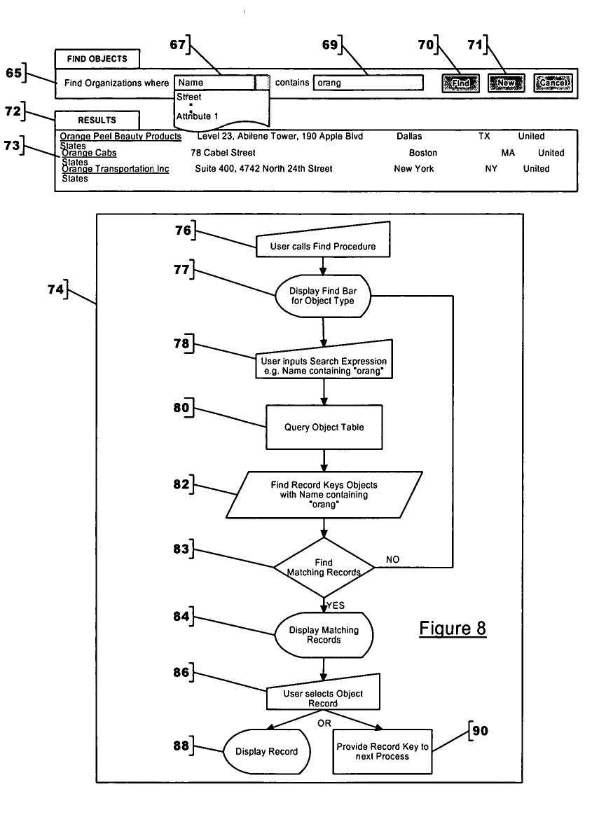

The user finds a record that they wish to work with using the steps shown in FIG. 8. Software 18 provides instructions to locate and retrieve records from Object tables that may be displayed to the user on a device such as a terminal 6. Alternatively, only keys of records may be retrieved from tables in order that the records may be used in other processes as will be described.

The user executes an instruction 76 while viewing an Object or by selecting from a menu of Objects that is displayed to the user using prior art methods. Instruction 76 causes the system to display 77 a form such as that shown 65, from which the user selects a type of criterion from a select list 67 of criteria. Each item displayed in list 67 relates to a corresponding column in an Object table.

In a preferred embodiment, the selection of items contained in the list 67 may also represent columns in non-Object tables that contain Object-related data and to which Object records are related by keys, such that when selected, keys to Object records meeting the selection criteria are identified and the related Object records fetched.

The user enters a search expression 78 into a data field 69 that relates to the type of data stored in the database that corresponds to the table column related to the item selected in list 67. The user then executes the search by clicking a Find button 70, which cause an instruction 80 to be issued to the server to query the subject Object table, for keys 82 to Object records that have the entered search expression in the table column represented by 67.

In a preferred embodiment, a plurality of criteria may be entered in the data entry field 69, representing a plurality of columns to be searched for the occurrence of the entered criteria.

Where one or more records exist that match 83 the user's criteria, the server then executes a set of instructions to select the Object records and display them 84 in tabular format such as that shown 72 with sufficient Object Information to enable the user to identify the Object 73. A hyperlink containing the unique key of each record is displayed for each record, such as for example by underlining the Object Name 73.

The listed Objects may also optionally have hyperlinks associated with other Object types to which they are related displayed with them that enables the user to access records other than that of the Object that was the cause of the initial search if authorized to do so).

Where no Objects meet the user's search expression 69, the system returns 83 to step 77 and re-displays the form 65 to enable the user to conduct a fresh search. If the user does not wish to conduct a further search they may cancel the operation and be returned to the state they were in prior to step 76.

In a preferred embodiment, software product 18 will provide an action 71 that is linked to the “Creating an Object Record” procedure that will enable a user to create a new Object record in the event the record they need does not already exist as will be described.

The procedure in the foregoing serves only to confirm the existence of a record relating to the Object. No information of significance about the Object is revealed.

Where Objects are displayed as shown in form 72, the user selects the Object to be viewed 86 by clicking the hyperlink of the associated Object record. The user's request is sent to the server, which selects the required record and displays it to the user 88 as an Object record, or alternatively the record is passed to other functions 90 in the software product as will be described later.

Record Group and Security Level of the Record Group are compared with the user's Security Profile(s) and if a) the view rights of the record are within those granted by the Security Profile, and b) the user has access to the associated procedure “calling” the record, the record is displayed to the user or provided to the procedure.

If the user has insufficient security access to view the record, a page is displayed to the user indicating their lack of security access and displays the Owner of the record, enabling the user to contact the Owner and request access.

Editing Object Records

To edit an Object record, the user accesses the record as described in “Accessing an Object Record”

The user's request is sent to the server, where Record Group and Security Level of the Object record are compared with the user's Security Profile(s) and if a) the edit rights of the record are within those granted by the Security Profile, and b) the user has access to the associated Service.

If the user is authorized to add a new Object or to edit an existing Object record an instruction is sent to the server to display a record form such as that in FIG. 3.

The user enters the details of the Object to be added or modifies those of an existing Object and the saves the record to store the changes in the Object table.

Relating an Object to another Object

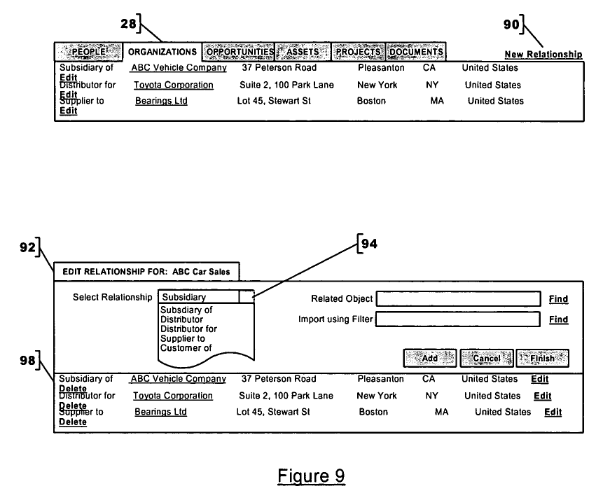

FIGS. 9 to 12 illustrate a sequence of steps to create a Relationship, which is a record that is stored in the Relationship Table 40 as shown in FIG. 4.

A Relationship may be created between two Objects by a user that has security access to at least one of the Objects (First Object).

To create a Relationship, the user must access the First Object record as described in “Accessing an Object Record”, which displays the record.

In a preferred embodiment the user accesses the part of the Relationship Section of the Object record that relates to the Object type to be related (Second Object) as shown in form 28 of FIG. 9, where the user selects the “New Relationship” action 90.

The user's request is sent to the server, where the Record Group and Security Level of the First Object record Group are compared with the user's Security Profile(s) and if a) the edit rights of the record are within those granted by the Security Profile, and b) the user has access to the associated Service, the procedure displays a form 92 to add a Relationship.

The form lists the Relationship Types 94 from the Relationship Type Table that are a) valid according to the Relationship Combination Table for the Object types to be related, and b) reflect the First Object's perspective of the Relationship e.g. in the case of an Employer of/Employee of Relationship where the Relationship is being added from the Organization Object, the user would only have the choice of Employer of (the Primary End) and not Employee of (the Secondary End) as the latter would only be applicable if the relationship were being added from a Person Object.

However, in the case of a Relationship between Objects of the same Object type e.g. a Person/Person Relationship, where either End may apply to either Object, the user will be presented with both Ends e.g. Parent of (Primary) and Child of (Secondary) from which to make a choice, as either would be valid for either Object.

In a preferred embodiment, details of the existing Relationships between the First Object and other Objects of the subject Relationship Combination are displayed 98, and in a further embodiment those of other Relationship Combinations may also be displayed, together with links to instructions that enable those Relationships to be modified or deleted.

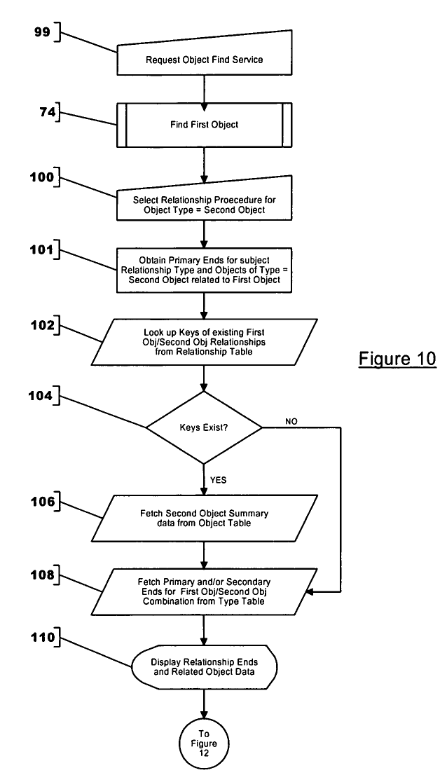

The processing steps in the procedures described above are shown in FIG. 10, which shows that the user selects a procedure 99 to find the First Object, which uses the “Accessing an Object Record” procedure 74 described earlier. When the First Object record is displayed, the user selects the Relationship procedure 100, which causes software product 18 to issue instructions to obtain the Primary ends for the Subject Relationship Type AND any Objects of the Second Object type that are related to the First Object.

The software product 18 then instructs 102 the Server to obtain the record keys of existing First and Second Object Relationships of the subject Relationship Combination from the Relationship Table 40 shown in FIG. 4. In further embodiments, the record keys of other Objects and Relationship Combinations that relate to the First Object may also be obtained.

Where the keys exist 104, they are temporarily stored by the procedure, which then proceeds to step 106. Where there are no keys i.e. there are no current Relationships between the First Object and the Second Object, or in other embodiments, any other Objects of the same or different Relationship Combination, the procedure goes directly to step 108.

In step 106, an instruction is sent to the server to obtain from the Object tables the summary data i.e. identification details, of those Objects to which the keys obtained in step 102 relate. This data is temporarily stored by the procedure preferably using prior art methods.

The software product 18 then instructs 108 the server to retrieve from the Relationship Type Table 40 the Primary Ends of the Relationship Types applicable to the subject Relationship Combination, that is, the Ends that are applicable to the First Object. There is an exception to this rule such that when the Relationship Combination is for Objects of the same Type, both Primary and Secondary Ends are retrieved as either End may be applied to the First Object.

The Relationship End data is displayed to the user 110 as a select list as shown previously 94, from which the user makes a selection of the Relationship End that is to be applied to the First Object with respect to the subject Relationship record.

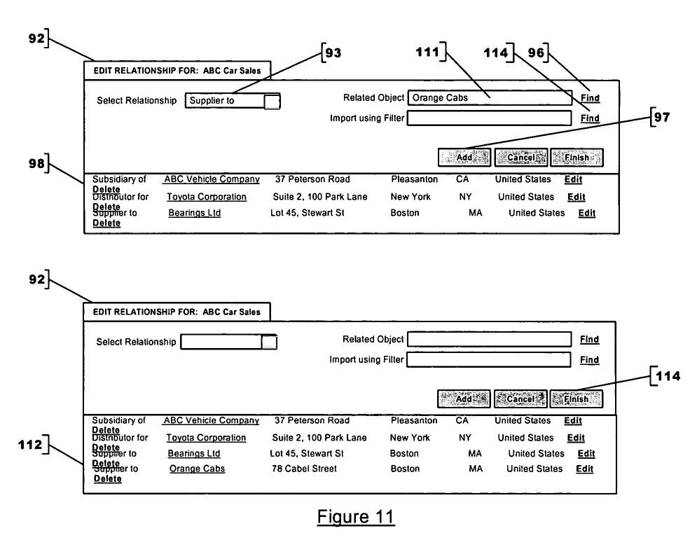

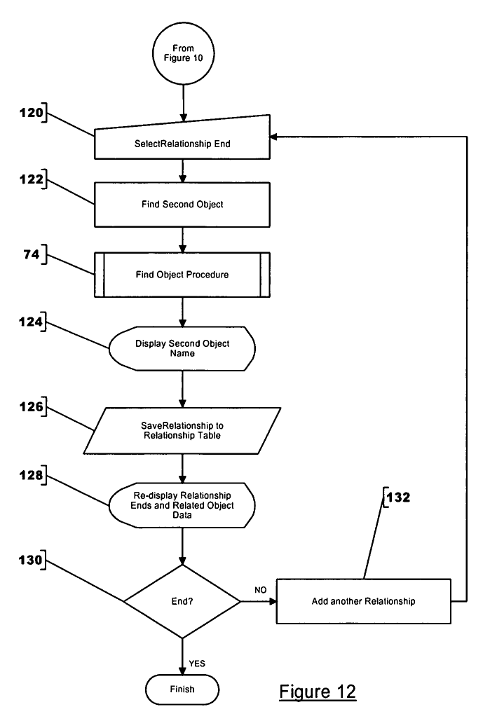

The next sequence of steps describes how the user interacts with the Relationship form and the instructions performed by the software product 18 as a consequence. The use of the Relationship form and resultant data displays is shown in FIG. 11 and the processing steps are shown in FIG. 12

The User selects the Relationship Type that is to be applied to the First and Second Object, by selecting the appropriate Primary End, as shown in form 92 of FIG. 11. In the case of a relationship between Objects of the same type, the user may alternatively select a Secondary End. In either case, the End selected is the one that reflects the perspective of the First Object with respect to the Second Object.

The user then selects a “Find” action 96 to find the Second Object, which uses the “Accessing an Object Record” procedure. The name of the selected Second Object is then displayed in the “Related Object” field 111 of the Relationship form.

In a preferred embodiment, the user may use a “Filter” by means of an action 113 that issues a set of instructions to software product 18 that will enable the user to select a plurality of Objects, all of which are to be related to the First Object, at the same time. The operation of Filters is described later.

The user then saves the Relationship record by clicking the “Add” button 97, which re-displays the form in the same state that it was when first displayed, except that that now the subject Relationship is also displayed in the Relationships Section 112.

The user may now create additional Relationships of different Types with the Second Object, or of the same or different Types with other Objects, using the sequence of steps as described above. If the user does not wish to add more Relationships they may select the Finish button 114 to end the Relationship creation process.

The processing steps in the procedures described above are shown in FIG. 12 and will now be described.

The user selects the desired Relationship End 120 using the select list 94 shown in FIG. 11. The user then initiates a procedure 122 to find the Second Object, which uses the “Accessing an Object Record” procedure 74 described earlier. The name of the Second Object is then displayed 124 to the user. The user then saves the Relationship, which is stored as a new record with a new key in the Relationship Table 40 shown in FIG. 4. The record keys of the First and Second Objects are stored in the corresponding columns in the Relationship Table.

The Objects stored in the First Object and Second Object columns of the Relationship Table 40 are related respectively to the Primary End and Secondary End columns of the Relationship Type Table 38 by virtue of the Relationship Type key which forms part of the Relationship record in the Relationship Table. When the Relationships of an Object record are viewed; the Primary End of the Relationship is displayed for the Object that has its key in the First Object column in the Relationship Table and the Secondary End for the Object that has its key in the Second Object column. Thus the End that correctly describes an Object's perspective in a Relationship is displayed with that Object.

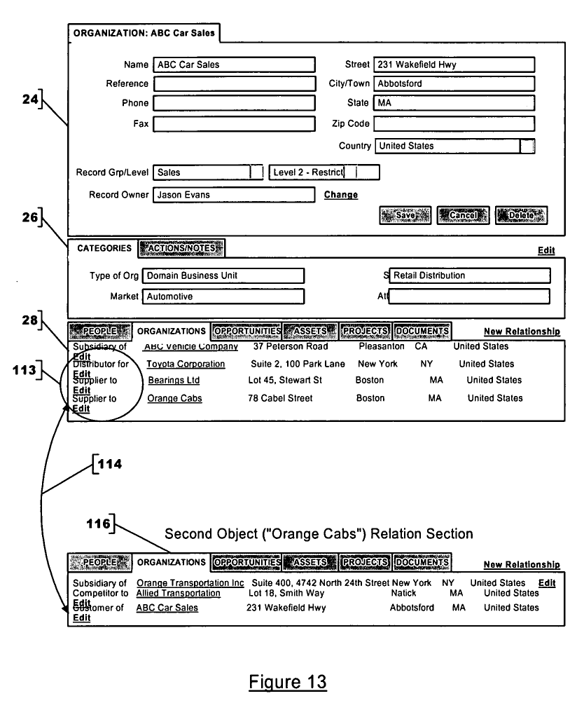

This is shown in FIG. 13, which illustrates the First Object Record. It can be seen that in the Relationship Section all Relationships that the First Object has with those of the same type as the Second Object are displayed, with each Relationship shown from the perspective 113 of the First Object with respect to each of the other Objects.

Similarly, when the Relationship Section of a Second Object is viewed 116, in this case, that of the Second Object used in the examples above, the perspective 114 of the Second Object with respect to the First Object i.e. Customer of, is the corollary of the First Object's view of the Second Object i.e. Supplier to.

### Other Embodiments

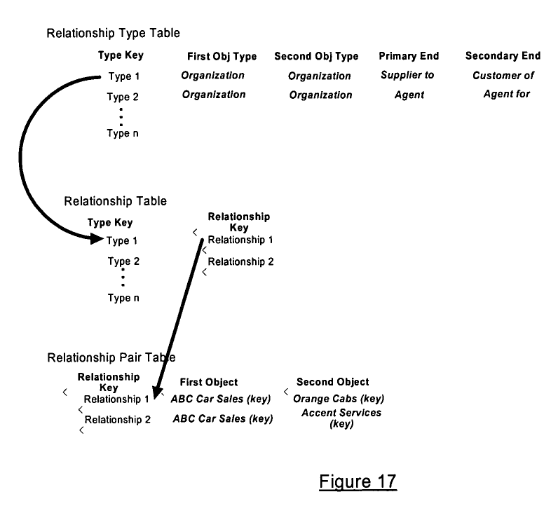

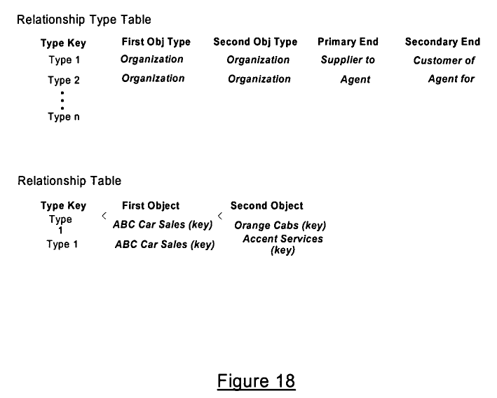

FIGS. 17 and 18 illustrate table structures that may be employed in alternative embodiments with respect to the way that Primary and Secondary Ends are applied to Relationships. These do not provide the benefits of the preferred embodiment described above, as the table structures are “de-normalized”, which results in disadvantages as would be well know to anyone practiced in the art of database design. The disadvantages include data replication, with the attendant risk of data duplication and the need to update multiple occurrences of the same type of data to ensure all records are related to the correct values.

Viewing Related Objects

Details of other Objects to which an Object (First Object) is related are displayed in the First Object's Relationship Section as shown in table 28 of FIG. 13, which may be further sub-divided into separate sections by Type of related Object for ease of Navigation as illustrated. Information sufficient to identify each Related Object (Second Object) is displayed together with the Relationship End representing the First Object's perspective of the Relationship. A user may if desired view the Second Object by clicking a hyperlink associated with it, which causes the Second Object record to be displayed provided the user has access permission to the record. When the Relationship Section of the Second Object is viewed, the reciprocal End to that displayed in the First Object together with the First Object's identity is displayed, also as a hyperlink to enable users to directly access the First Object record.

All Objects to which an Object is related may be accessed from the Object's record, which enables users to navigate via direct links to related information. As all Relationships are reciprocal users are able to return to their origin using a single action e.g. mouse-click.

Retrieving Information

Because of the way information is stored, users have considerable flexibility in retrieving information from the system. For example, they might nominate an explicit context:

“Sales Opportunities for which Mary Smith Ltd is related as an influencer”; or a narrower context as follows:

“Sales Opportunities for which Mary Smith is related as an influencer AND the Prospects (Organizations) are in the food delivery OR manufacturing business” and then even narrower as follows:

AND where XYZ Organization is related to the Sales Opportunities as a Competitor.

Alternatively a user may retrieve information by Relationship Type alone, for example “ALL people that occupy a Position in XYZ Organization”, or

All Organizations that are Suppliers

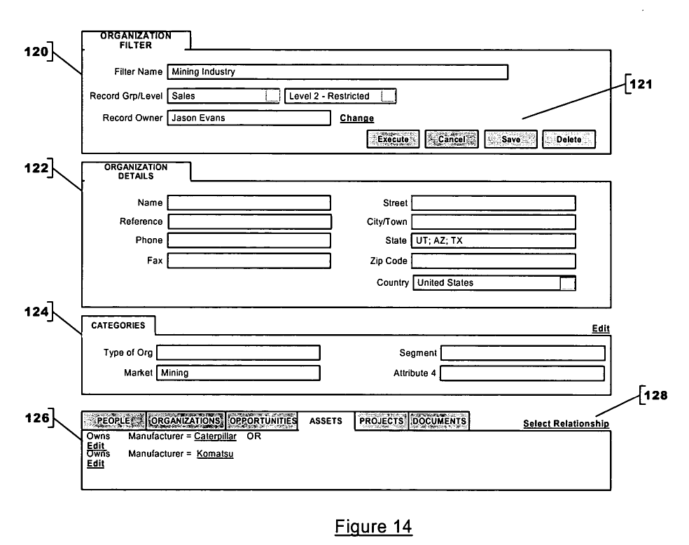

The form of FIG. 14 illustrates a Filter form that is generated during execution of software product 18 for the purpose of allowing a user to specify the search terms they wish to use to retrieve specific Objects of interest from the management information system. Search criteria may include any selection of Object identification details e.g. name and address, Categories information and/or Relationships Types where Objects are to be retrieved that are related by one or more nominated Relationship Types to other Objects. When executed by a user, the Filter will retrieve the sub-set of records from Object tables that meet the Filter's search criteria

In the example an Organization Object Filter is shown. In the Header 120 of the Filter record, the user has entered a name for the Filter and also the security that is to apply to the Filter, which will govern who may execute and/or modify the search criteria of the Filter.

In the Object Details Section 122 the user has nominated that the Object addresses must be in the States of “UT, AZ” or “TX”. The user has further nominated in the Categories Section 124 that the Organizations must also own Assets where the Manufacturer is “Caterpillar” or “Komatsu”

The user may also nominate the Type(s) of Relationship(s) that Objects that are the subject of the Filter must have with other Objects. The user enters these criteria in the Relationship Section 126 of the Filter, which in a preferred embodiment is in the same form as the Relationship Section of Objects 28 as shown in FIG. 3. It is also a preferred embodiment that the selection of Relationship Types and Related Objects for the purposes of nominating the search criteria of the Filter will be the same as that of “Relating an Object to another Object” as described earlier and as shown in FIGS. 9 to 12, which provides the advantage of using the same instructions of software product 18 as are used for relating Objects. In addition, the preferred embodiment provides users with a consistent mode of operation, which reduces the time necessary for them to learn the operation of the system.

To nominate Relationships that are to be used for selection criteria in a Filter, the user selects the “Select Relationships” action 128 which generates the same set of instructions in software product 18 as that are generated by the “New Relationship” action 90 shown in FIG. 9 which is part of the “Relating an Object to another Object” procedure as described earlier.

Upon creating a Filter, the user may execute it by clicking a button 121, which will retrieve the Object records meeting the criteria of the Filter to be displayed in tabular form substantially in the form 73 of that shown in FIG. 8. In other embodiments, additional information may be retrieved such as Asset details entered as part of the search criteria.

Having identified the relevant Objects, users may then “visit” (view) them, sourcing information related to them. Alternatively, the set of records derived from the execution of a Filter may be used in other contexts; for example, to create other Relationships where the set of Objects are to be related (individually) to another Object e.g. as targets in a marketing campaign (a Relationship to a Project Object) or as invitees to a promotional event (a Relationship to both Email and Project Objects). In this case a Filter may be referenced instead of a single Second Object in the “Relating an Object to another Object” procedure, in which case a Filter may be nominated in the “Import Using Filter” field as shown in Form 92 in FIG. 11.

Filter operation may be restricted to only retrieve records to which the user has security access.

Security

Software product 18 includes instructions for implementing a security model that controls user's access to Object record and to system functions or services:

The first of these is “Record Security”, which controls the level of security associated with an Object and Service security, which controls which System Services or functions within the information system that a user has access to. The security level for each Object record is stored in its corresponding “Record Group” and “Security Level” columns as shown in the tables of FIG. 2. The second component is the implementation of “Security Profiles”, which are granted to users and which lists the System Services available to the Profile, and a selection of particular Record Groups and a view/edit Security Level applicable to each. The Security Profiles, one or more of which may be granted to each user, determine a user's access to view information stored in the information management system and that user's power to edit the records and relationships that are stored. Each user will have the key(s) of the Profiles granted to them stored in his/her user record.

Each Object record belongs to a Record Group and has a Security Level applied to it, which is set by the record Owner. The record Owner is nominally the user that created the record, however that may be changed to any other user and in practice the Record Group is likely to be analogous to the workgroup the Owner is associated with. In a preferred embodiment all other records in the information systems will also belong in a Record Group and have a Security Level applied to them.

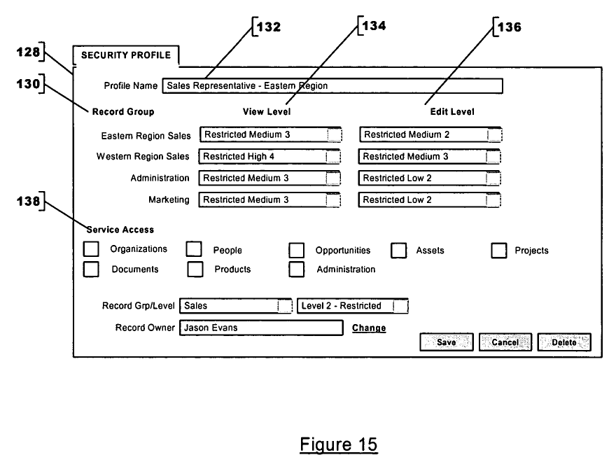

A Security Profile is a record that defines the edit and view Security Levels for nominated Record Groups and levels of access to the information system's Services and may be in a form such as that shown in FIG. 15

The form contains fields for the Security Profile Name 132, and select lists of Security Levels that enable the user to nominate the view 134 and edit 136 levels that are to apply to each Record Group 130 in the Domain for the subject Profile. Security Levels are interpreted as meaning that a higher value is more secure than a lower value, such that a Security Profile that provides a view Level of 3 (say) to a particular Record Group entitles users with the Profile to view all records in that Group that have a Security Level of 1, 2 or 3, but not those of 4 or higher. Where a user has been granted a plurality of Security Profiles and they have different i.e. conflicting, Security Levels for any Record Group are different, the user is granted the highest Security Level that appears in any of his/her Security Profiles for the purposes of accessing that Record Group

In addition, the form contains checkboxes or in other embodiments other devices, to enable the user to select the Services in the information system that are to apply to the subject Profile. The data entered in the form is saved to a Security Profile Table.

Users are granted one or more Profiles, by the keys of the Profiles being added to their user records.

In addition all of the Object type tables have in common fields for “Owner” “Record Group” and “Security Level”. The Owner field stores the key that identifies the Object record of the user of the system that created, and/or who has principal responsibility for the particular Object record. For example Organization 1 in the Organization Type Object table may have user XYZ's key stored in its Owner field. The Record Group field stores a key that defines the Record Group to which the Object belongs for the purposes of classifying records according to their security needs and the Security Level field stores a security level value that determines the rights that a user of the system has in relation to Objects within the associated Record Group. For example a user of the system may have rights to view and/or add and/or edit and/or delete the records or data stored in the fields of records within particular Record Groups.

Exploring Object Records

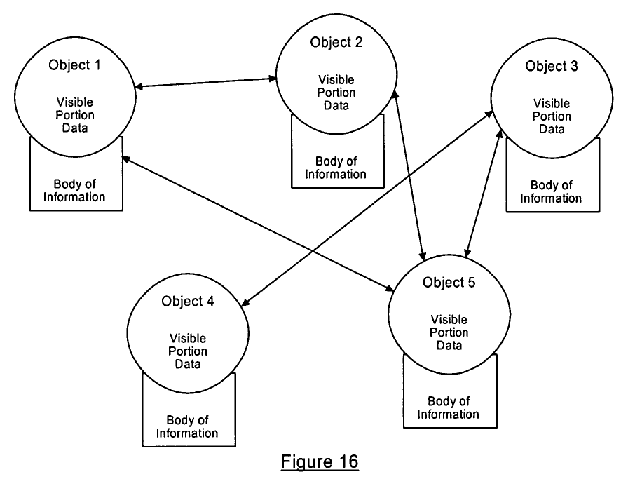

Users may discover the existence of an Object record without having access to all data in the record or details of everything (other records) that the Object is related to. For example, FIG. 16 illustrates a situation wherein five document type objects are interrelated. A particular user may have a Security Profile that allows viewing of the Titles and data identifying the Owners of the Objects. Accordingly the Titles and the Owners may be thought of as being placed in a visible portion of the object's data with respect to the particular user. The remainder of the Object is stored in the body of information section. Depending on the user's security profile the document file itself may not be accessible although the “header” information about the document stored in the visible portion is. This information includes the identity of the Owner of the document. Consequently the user may approach the Owner and ask for a paper copy of the document or ask for specific access in order that he may gain access to the complete object.

As illustrated in FIG. 16, the relationships between Objects are visible to a user that has view access to at least one of the Objects. A user that does not have a security profile to enable him/her to view all of an Object's data may nevertheless create a new relationship between that Object and another (Second Object) if he/she does have access to the Second Object.

As each Object has it's own security, access to a given Object does not provide access to other Objects it is related to. A user must have explicit access to every record they wish to access. For example, a user may have access to a Sales Opportunity record showing details of product to be sold, value, stage of the sale, anticipated close date etc, however they may not have access to a copy of the Sales Proposal (a document) or to the Objects records of the People and Organizations related to it as they may have a different Security Levels.

Conversely, a user could, say, have access to a Proposal Document but not to its related Opportunity, so they would not be able to access the Document from the Opportunity, instead they would need to access the Proposal from another Object that is related to that they did have access to e.g. their Position or Office (Organization) Objects.

The way that the information management system manages information could be likened to a filing cabinet in an office; a user may have access to an office but not necessarily to every cabinet. In the system a user must have access to a record's physical location (office) and to the item itself (cabinet); in the case of the system this would be the discrete record.

The security model allows users to store any information they come across wherever they believe it logically belongs i.e. in contexts meaningful to them, which reflects the way people intuitively work. However, as users cannot be aware of the full scope of relationships or information linked to the records they are “copying” it is highly desirable that each item of information has explicit security that cannot be compromised, which is what the information management system does.

For example, if a user came across a document associated with Organization B and decided to also associate it with Organization C, that does not mean that users that have access to C, but not to B, can access the document. Access to the document is still restricted to only those with access to the Record Group and Security Level associated with the document.

Regardless of how complex the linking of information, users can “copy” with impunity knowing that at all times item-level (record) security will control who accesses what.

Users may relate Objects to other Objects that they do not have record-level access to (doing so does not of course grant access to the other Object), provided they have access to the other Object to which it is to be related. This means that the information management system permits users to become aware of the existence of an Object even though they have do not have access to its record i.e. they cannot glean any material knowledge about it. This confers a number of useful benefits:

1. It overcomes a problem with prior art approaches that ignorance of an Object's existence may lead users to think it doesn't exist at all, which may result in their creating a duplicate Object

2. A user's inability to access an Object may not be a deliberate denial; they may be entitled to the information, however they don't happen to have the appropriate Security Profile to get to it. By being aware of the Object they are in a position to request access (the Owner of a record may grant a nominated user access to the record notwithstanding the user's Security Profile(s) would not otherwise allow them to access it).

3. The fact a user cannot obtain information about an Object per se, does not prevent them associating other relevant information with it for example, a user may have become aware that John Smith has just become Director of Organization XYZ that the user is responsible for. Even though the user cannot access John Smith's record he should not be prevented from creating a connection between XYZ and Smith.

4. The fact that the creator of a record is freely acknowledged when the record is viewed encourages user's to contribute their information. This is to be preferred to alternative approaches, where records do not have a defined single owner or else record ownership is not immediately apparent to anyone that attempts to access the record, as user's have a natural fear that they will lose control of their personal contributions, or even worse that others will explicitly or implicitly receive such credit.

5. The next time the “Owner” of the John Smith record views it, they will become aware of his involvement with Organization XYZ.

As this process repeats itself in multiple contexts, knowledge grows as does user awareness of the sources of knowledge e.g. in 2 to 4 above, the users are now able to communicate with each other to learn more about the relationships that affect Objects they are interested in.

A summary of the terms discussed above appears in the following Table 1.

TABLE 1

| | |
|---|---|
| Domain | A logical grouping of Object records, Relationships, |
| | Object Attributes, users, Record Groups and Security |
| | Profiles. A Domain defines the “view limits” that a user |
| | has of the system. Each of the previously listed items |
| | is associated with a single and specific Domain. |
| | Domains have a unique key and name associated with |
| | them. A Domain is also an Object record and an |
| | Object in it's own right. A user must log in to a domain |
| | and once logged in only the previous listed items |
| | marked as belonging to that Domain are visible to the |
| | user. |
| Object | A virtual occurrence of any thing of interest to the user |
| | organization. May represent a physical thing e.g. |
| | Organization, Person, Asset, Document etc or non- |
| | physical thing e.g. Position or Project. |
| | An Object is a discrete item that has a context of itself and |
| | to which one or more other Objects may be related by |
| | defined Relationship Types, each of which places them in |
| | a specific context with the first Object. |
| | An Object record may be created for every item that is of |
| | interest to the user organization. |
| Object | User-defined characteristics of an Object type that |
| Attributes | permit the characteristics of individual Objects to be |
| | described and categorized according to a user-defined |
| | model. |
| | Each Object Attribute may have one or more user- |
| | defined values associated with it. |
| Object | A record that is created for each Object, each of which |
| record | has a key that uniquely identifies the Object. |
| | Has user-enterable fields for Object Information that |
| | describes the identity of the Object |
| Object types | Objects are of a Type e.g. Organization, Person, |
| | Asset, each of which is defined by Attributes that are |
| | typical of the Object and that characterize it. |
| | Each Object type is associated with it's own Object |
| | table |
| Record | A logical group to which an Object record belongs |
| Group | |
| record | A user that is able to create Object records and to set |
| Owner | the Record Group and Security Level of a record. |
| | A record Owner's ownership rights may be delegated |
| | to one or more other users |
| Relationship | A user-defined data Object that describes a single two- |
| | way relationship between two Objects of a specific |
| | Relationship Type. An Object may have any number |
| | of Relationships between it and one or more other |
| | Objects. Relationships are stored in the Relationship |
| | Table |
| Relationship | Relationships may exist between valid combinations of |
| Combination | two Object types e.g. Organization/Organization; |
| | Organization/Person; Person/Asset, that are |
| | maintained in the Relationship Combination Table |
| Relationship | The opposite ends of a Relationship Type (and hence |
| End | Relationship), each of which is associated with a |
| | specific Object as either the Primary or Secondary |
| | End. The Ends of a Relationship Type may have the |
| | same or different names e.g. |
| | Parent of (primary)<<>>Child of (secondary) |
| | Associate of (primary)<<>> Associate of (secondary) |
| Relationship | A user-defined Relationship between the two Objects |
| Type | of a specified Relationship Combination. Each |
| | Relationship Combination may be associated with a |
| | number of Relationship Types that define specific |
| | types of Relationships that may exist between two |
| | Objects. Each Type is associated with two |
| | Relationship Ends (Primary and Secondary) that |
| | reflect each Object's perspective of the Relationship. |
| | Each Type is unique such that a relationship that |
| | exists between one Type pair cannot also exist |
| | between another Type pair e.g. a Relationship Type |
| | that relates an Organization and Asset may not also |
| | be used to relate a Person and an Asset (Relationship |
| | Type keys cannot be the same). |
| | Any number of Relationship Types may be created for |
| | each Object Combination; they are stored in the |
| | Relationship Type Table, each with a unique key. |
| Security | Arbitrary Levels of Security that are associated with an |
| Levels | Object Group and which may be applied independently |
| | to each record to control access rights to the record |
| | such as, “add”, “view”, “edit” and “delete” e.g. users |
| | with view access to Level 2, would be able to view |
| | records with Level 1 or 2 Security but not Level 3 and |
| | above |
| Security | A record that defines one or more Record Groups and |
| Profile | the associated Security Levels of each that is used to |
| | control user access to records. |
| | Each user is allocated one or more Security Profiles. |
| System | An arbitrary name allocated to a “function” within the |
| Service | information system that enables operations to be |
| | performed on Objects, such as adding, editing and |
| | deleting Objects. Services provide a high level |
| | mechanism to restrict a user's ability to perform |
| | actions within the system. Each Service is allocated a |
| | unique name and key. |
| User | A Person (defined by a Person Object) that may login |
| | to a Domain. |
| | The User Object record has a unique ID and contains: |
| | Domain ID, user ID, Password |
| | A key to the Person Object that identifies a person |
| | keys that relate to the Security Profile(s) granted to the |
| | user |
| | Names of the Services the user is authorized to |
| | access |

It will, of course, be realized that the above has been given only by way of illustrative example of the invention and that all such modifications and variations thereto as would be apparent to persons skilled in the art are deemed to fall within the broad scope and ambit of the invention defined by the following claims.

1. A method of operating a computer system to manage information about a domain of objects representing things of interest to an organization, said objects being instances of object types of the domain, the method including the steps of:
defining relationship types between pairs of object types each definition including;
information identifying first and second object types,
a primary end being a descriptor of the first object type's relationship to the second object type,
a secondary end being a descriptor of the second object type's relationship to the first object type; and
defining relationships between pairs of objects, each relationship being an instance of a user selected relationship type;
wherein primary and secondary ends are associated with each relationship on the basis of
user selection of either the primary or the secondary end of the user selected relationship type, and
retrieval of the other of said ends from the relationship type definition without user input.

2. A method according to claim 1, including:
presenting object information of a first object; and
presenting either the first end or the second end of a relationship between the first object and a second object depending on user preference.

3. A method according to claim 1, wherein the step of defining relationship types involves a dedicated relationship type table.

4. A method according claim 3, wherein said relationship type table includes columns storing keys to valid combinations of object types and first and second ends.

5. A method according to claim 1, wherein the step of defining relationships involves a relationship table including a key to the relationship type table and a column storing keys of each object.

6. A method according to claim 1, including defining relationship types between pre-defined pairings of object types only.

7. A method according to claim 2, wherein the step of presenting object information about the first object includes providing links to view object information about each object to which the first object is related.

8. A method according to claim 7, including restricting operation of the link depending on a security profile of the user.

9. A method according to claim 8, including associating security levels with objects in order that only users with certain predefined security profiles are able to access object information of selected objects.

10. A method according to claim 1, including checking that no two relationship types have the same end names.

11. A method according to claim 2, including controlling user access to portions of the object information and relationship information in respect of an object on the basis of predefined user security profiles.

12. A method according to claim 2, including associating security levels with objects in order that only users with certain predefined security profiles are able to define relationships between objects.

13. A computer system programmed to implement a method according to claim 1.

14. A computer system programmed to implement a method according to claim 9.

15. A computer software product comprising media bearing instructions for execution by one or more electronic processors comprising instructions to execute a method according to claim 1.

16. A computer software product comprising media bearing instructions for execution by one or more electronic processors comprising instructions to execute a method according to claim 9.

17. An article of manufacture comprising a program storage medium readable by a computer to manage information about a domain of objects representing things of interest to an organization, said objects being instances of object types of the domain, the program storage medium including:
instructions to form definitions of relationship types between pairs of object types each definition including;
information identifying first and second object types,
a primary end being a descriptor of the first object type's relationship to the second object type,
a secondary end being a descriptor of the second object type's relationship to the first object type;
instructions to form definitions of relationships between pairs of objects, each relationship being an instance of a user selected relationship type; and
instructions to associate primary and secondary ends with each relationship on the basis of user selection of either the primary or the secondary end of the user selected relationship type and retrieval of the other of said ends from the relationship type definition without user input.

18. An article of manufacture comprising a program storage medium readable by a computer, the program storage medium including instructions to implement a method according to claim 10.

19. A system for managing information comprising:
a storage device;
a display;
a user input;
a processor programmed to:
(a) enable user data entry for a plurality of pairs of objects of a database that includes object identification data, object category data, object attribute data, and object relationship data wherein the object relationship data entered for one of the plurality of pairs of objects defines one of a plurality of different types of relationships between the one of the plurality of pairs of objects and another one of the plurality of pairs of objects that includes a plurality of relationship descriptors with one relationship descriptor associated with the one of the plurality of pairs of objects and the other one of the relationship descriptors associated with the other one of the plurality of pairs of objects;
(b) generate all possible combinations of object pairs with each object pair combination assigned a unique combination key and stored in a relationship combination table;
(c) generate a relationship type table that includes, for each combination key, a plurality of relationship descriptors assigned a unique associated type key and associated with a corresponding one of the combination keys of the relationship combination table;
(d) generate a relationship table the includes the object of each one of the object pairs of the object pair combinations assigned a unique associated relationship key and associated with a corresponding one of the type keys of the relationship type table; and
(e) permitting a user to navigate between a plurality of the objects using the relationship defined therebetween.
